(19) United States
(12) Patent Application Publication
(10) Pub. No.: US 2022/0197946 A1
(43) Pub. Date: Jun. 23, 2022

(54) METHOD AND SYSTEM FOR IMPLEMENTING GLOBAL INDEX OF ARTS PRACTITIONERS

(71) Applicant: Rhovan L. Curtis, Coral Springs, FL (US)

(72) Inventor: Rhovan L. Curtis, Coral Springs, FL (US)

(21) Appl. No.: 17/129,790

(22) Filed: Dec. 21, 2020

(51) Int. Cl. G06F 16/901; G06Q 20/40

(52) U.S. Cl. CPC G06F 16/9017; G06Q 20/401

(57) ABSTRACT

The present disclosure provides a system and method for implementing a global index of a plurality of arts practitioners. The system provides the global index that includes a browsable catalog of the plurality of arts practitioners that allows a plurality of users to navigate information associated with the plurality of arts practitioners. In addition, the system enables each of the plurality of users to navigate the information associated with the plurality of arts practitioners and place a request on one or more communication devices based on a plurality of parameters. Further, the system retrieves at least one arts practitioner from the plurality of arts practitioners using the global index based on the request of each of the plurality of users. Furthermore, the system displays the at least one arts practitioner and the physical location on the one or more communication devices of the plurality of users.

### TECHNICAL FIELD

The present invention relates to the field of online platforms and, in particular, relates to a method and system for implementing global index of arts practitioners.

### INTRODUCTION

With the propagation of internet, consumers increasingly make purchases from online merchants. The purchases from the online merchants are almost from every department, for example, grocery, furniture, electronics, etc. However, recording studios and art studios are hard to find online and online merchant's availability is very difficult. Manually searching for recording facilities is a tedious task and consumes a large amount of time. In addition, manually searching for recording facilities based on the geographical location is very difficult. Conventionally, manually inputting the logistics is the laborious task for finding the industry standard studios & recording facilities into navigation platforms such as Waze, Google Maps, Uber, Lyft, etc. In addition, knowing the rating of the online merchant can help to understand the behavior and service experience. On the other hand, after all the manual effort, one cannot find rating of the online merchant based on the other user's previous experience.

In light of the foregoing discussion, there exists a need for a new and improved system which overcomes the above-cited drawbacks of conventional system.

### SUMMARY

In an aspect, a computer-implemented method is provided. The computer-implemented method for implementing a global index of a plurality of arts practitioners. The computer-implemented method includes a first step of providing the global index that includes a browsable catalog of the plurality of arts practitioners that allows a plurality of users to navigate information associated with the plurality of arts practitioners. The computer-implemented method includes a second step of enabling each of the plurality of users to navigate the information associated with the plurality of arts practitioners and place a request on one or more communication devices. Further, the request is based on a plurality of parameters including an identification of a physical location and a context of the request. The computer-implemented method includes a third step of retrieving at least one arts practitioner from the plurality of arts practitioners using the global index based on the request of each of the plurality of users. In addition, the at least one arts practitioner from the plurality of arts practitioners is retrieved in real-time. The computer-implemented method includes a fourth step of displaying the at least one arts practitioner and the physical location on the one or more communication devices of the plurality of users. In addition, the at least one arts practitioner and the physical location are displayed in real-time.

In an embodiment of the present disclosure, the computer-implemented method further includes a step of receiving from at least one user of the plurality of users a booking request to book the at least one arts practitioner of the plurality of arts practitioners. The computer-implemented method includes another step of receiving a confirmation from the at least one arts practitioner of the plurality of arts practitioners and an acceptance from the at least one arts practitioner of the plurality of arts practitioners accepting special instructions of the plurality of users included in the booking request. The computer-implemented method includes yet another step of processing a payment transaction between the at least one user of the plurality of users and the at least one arts practitioner of the plurality of arts practitioners for finalizing the booking request.

In an embodiment of the present disclosure, the computer-implemented method further includes a step of weighting the at least one arts practitioner of the plurality of arts practitioners based on information reflective of affinity of the at least one user of the plurality of users for corresponding arts practitioner, such that at least some of the plurality of arts practitioners are weighted differently than others. In addition, the amounts by which the at least one arts practitioner is weighted influences a likelihood that the at least one arts practitioner will be selected to recommend to the plurality of users. Further, weighting the at least one arts practitioner by an amount that depends upon an explicit rating by the corresponding user of the plurality of users.

In an embodiment of the present disclosure, the computer-implemented method further includes a step of integrating at least one mapping module with the global index for enabling each of the plurality of users to navigate the information associated with the plurality of arts practitioners directly to the physical location on at least one map of the at least one mapping module.

In an embodiment of the present disclosure, the computer-implemented method further includes a step of receiving a registration of the at least one arts practitioner of the plurality of arts practitioners at the global index. The computer-implemented method includes another step of receiving product/service information of the at least one arts practitioner of the plurality of arts practitioners. The computer-implemented method includes yet another step of receiving local service settings of the at least one arts practitioner of the plurality of arts practitioners. The computer-implemented method includes yet another step of updating a status of the product/service information and the local service settings of the at least one arts practitioner of the plurality of arts practitioners.

In an embodiment of the present disclosure, the global index corresponds to a global chart that has substantially all information associated with the plurality of arts practitioners.

In an embodiment of the present disclosure, the context of the request includes at least one of type of product/service information, type of the plurality of arts practitioners, type of at least one mapping module, experience of the plurality of arts practitioners, a user profile and an explicit rating of the plurality of arts practitioners.

In another aspect, a computer system is provided. The computer system may include one or more processors and a memory coupled to the one or more processors. The memory may store instructions which, when executed by the one or more processors, may cause the one or more processors to perform a method. The method for implementing a global index of a plurality of arts practitioners. The method includes a first step of providing the global index that includes a browsable catalog of the plurality of arts practitioners that allows a plurality of users to navigate information associated with the plurality of arts practitioners. The method includes a second step of enabling each of the plurality of users to navigate the information associated with the plurality of arts practitioners and place a request on one or more communication devices. Further, the request is based on a plurality of parameters including an identification of a physical location and a context of the request. The method includes a third step of retrieving at least one arts practitioner from the plurality of arts practitioners using the global index based on the request of each of the plurality of users. In addition, the at least one arts practitioner from the plurality of arts practitioners is retrieved in real-time. The method includes a fourth step of displaying the at least one arts practitioner and the physical location on the one or more communication devices of the plurality of users. In addition, the at least one arts practitioner and the physical location are displayed in real-time.

In yet another aspect, a computer-readable storage medium is provided. The computer-readable storage medium encodes computer executable instructions that, when executed by at least one processor, performs a method. The method for implementing a global index of a plurality of arts practitioners. The method includes a first step of providing the global index that includes a browsable catalog of the plurality of arts practitioners that allows a plurality of users to navigate information associated with the plurality of arts practitioners. The method includes a second step of enabling each of the plurality of users to navigate the information associated with the plurality of arts practitioners and place a request on one or more communication devices. Further, the request is based on a plurality of parameters including an identification of a physical location and a context of the request. The method includes a third step of retrieving at least one arts practitioner from the plurality of arts practitioners using the global index based on the request of each of the plurality of users. In addition, the at least one arts practitioner from the plurality of arts practitioners is retrieved in real-time. The method includes a fourth step of displaying the at least one arts practitioner and the physical location on the one or more communication devices of the plurality of users. In addition, the at least one arts practitioner and the physical location are displayed in real-time.

### BRIEF DESCRIPTION OF THE DRAWINGS

Having thus described the invention in general terms, reference will now be made to the accompanying drawings, which are not necessarily drawn to scale, and wherein:

FIG. 1 illustrates an interactive computing environment to implement a global index of a plurality of arts practitioners, in accordance with various embodiments of the present disclosure;

FIG. 2 illustrates a flow chart of the method to implement the global index of the plurality of arts practitioners, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

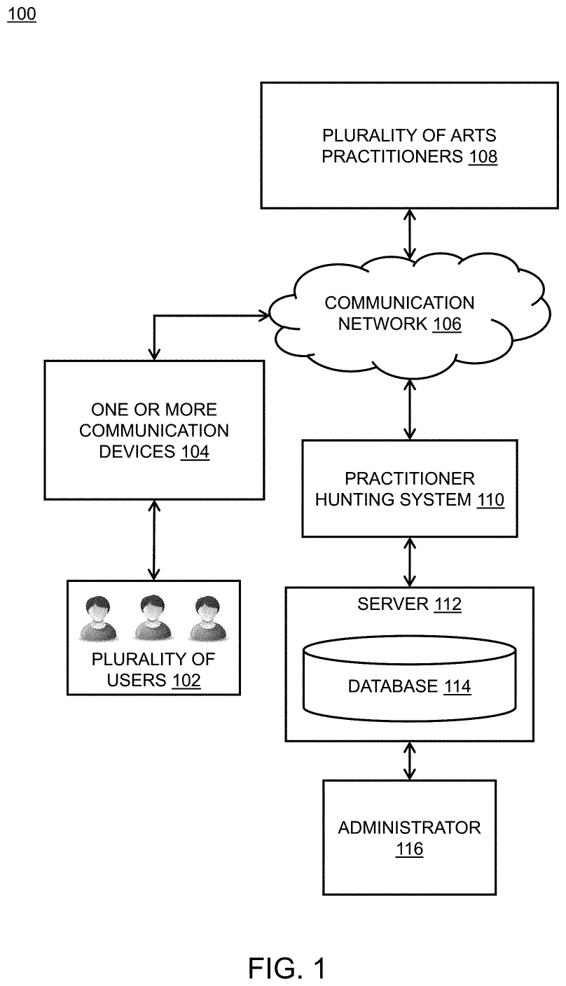

FIG. 1 illustrates an interactive computing environment 100 to implement a global index of a plurality of arts practitioners 108, in accordance with various embodiments of the present disclosure. The interactive computing environment 100 includes a plurality of users 102, one or more communication devices 104, a communication network 106, and the plurality of arts practitioners 108. In addition, the interactive computing environment 100 includes a practitioner hunting system 110, a server 112, a database 114, and an administrator 116. The above stated elements of the interactive computing environment 100 operate coherently and synchronously to enable implementation of the global index of the plurality of arts practitioners 108. The global index corresponds to a global chart that has substantially all information associated with the plurality of arts practitioners 108.

In an example, the global index corresponds to android operating system compatible marketplace. In another example, the global index corresponds to windows operating system compatible marketplace. In yet another example, the global index corresponds to iPhone operating system compatible marketplace. In yet another example, the global index corresponds to mac operating system compatible marketplace. In yet another example, the global index corresponds to web-based marketplace. However, the global index is not limited to the above-mentioned marketplaces.

The interactive computing environment 100 includes the plurality of users 102. The plurality of users 102 corresponds to any number of person or individual associated with the practitioner hunting system 110. The practitioner hunting system 110 accesses data associated with each of the plurality of users 102 and the plurality of arts practitioners 108. In addition, the plurality of users 102 may be any person or individual accessing the one or more communication devices 104. In an embodiment of the present disclosure, the plurality of users 102 is an owner of the one or more communication devices 104. In another embodiment of the present disclosure, the plurality of users 102 is not the owner of the one or more communication devices 104. In an embodiment of the present disclosure, the plurality of users 102 accesses the one or more communication devices 104 at home. In another embodiment of the present disclosure, the plurality of users 102 accesses the one or more communication devices 104 at a cafe. In yet another embodiment of the present disclosure, the plurality of users 102 accesses the one or more communication devices 104 in an office. In an example, a user U1 accesses a smartphone S1 while sitting in a living room. In another example, a user U2 accesses a laptop L1 while travelling from one place to another. In yet another example, a user U3 accesses a desktop computer D1 while working in the office.

The plurality of users 102 accesses the global index through the one or more communication devices 104 having the practitioner hunting system 110. The one or more communication devices 104 are associated with the plurality of users 102. Furthermore, the practitioner hunting system 110 receives information associated with the plurality of arts practitioners 108. The information includes but may not be limited to name data, age data, e-mail identity data, contact number data, geographic location data, and product/service information. Also, the information includes but may not be limited to payment cards information and banking partners information. In an embodiment of the present disclosure, the information is received from the plurality of arts practitioners 108, social media database, and third-party database.

The interactive computing environment 100 includes the plurality of users 102 who is any person present at any location and accessing the global index of the plurality of arts practitioners 108. The plurality of users 102 is any legal person or natural person who access the global index of the plurality of arts practitioners 108 and need an IP based network for accessing the global index of the plurality of arts practitioners 108. In addition, the plurality of users 102 is an individual or person who access the global index of the plurality of arts practitioners 108 through the one or more communication devices 104.

The interactive computing environment 100 includes the one or more communication devices 104. The plurality of users 102 is connected with the interactive system 100 through the one or more communication devices 104. In an embodiment of the present disclosure, the one or more communication devices 104 facilitate access to the global index of the plurality of arts practitioners 108 through the practitioner hunting system 110. In an embodiment of the present disclosure, each of the one or more communication devices 104 is a portable communication device. The portable communication device includes but may not be limited to a laptop, a smartphone, a tablet, and a smart watch. In an example, the smartphone may be an iOS-based smartphone, an android-based smartphone, a windows-based smartphone and the like. In another embodiment of the present disclosure, each of the one or more communication devices 104 is a fixed communication device. The fixed communication device includes but may not be limited to a desktop, a workstation, a smart TV and a mainframe computer. In an embodiment of the present disclosure, the one or more communication devices 104 are currently in the switched-on state. The one or more communication devices 104 are any type of devices having an active internet. In addition, each of the plurality of users 102 accesses corresponding communication device of the one or more communication devices 104 in real-time.

In an embodiment of the present disclosure, the practitioner hunting system 110 performs computing operations based on a suitable operating system installed inside the one or more communication devices 104. In general, the operating system is system software that manages computer hardware and software resources and provide common services for computer programs. In addition, the operating system acts as an interface for software installed inside the one or more communication devices 104 to interact with hardware components of the one or more communication devices 104. In an embodiment of the present disclosure, each of the one or more communication devices 104 performs computing operations based on any suitable operating system designed for the portable communication device. In an example, the operating system installed inside the one or more communication devices 104 is a mobile operating system. Further, the mobile operating system includes but may not be limited to windows operating system, android operating system, iOS operating system, Symbian operating system, BADA operating system from Samsung Electronics and BlackBerry operating system, and Sailfish. However, the operating system is not limited to above mentioned operating systems. In an embodiment of the present disclosure, the one or more communication devices 104 operate on any version of particular operating system corresponding to above mentioned operating systems.

In another embodiment of the present disclosure, the practitioner hunting system 110 performs computing operations based on any suitable operating system designed for fixed communication device. In an example, the operating system installed inside the one or more communication devices 104 is Windows. In another example, the operating system installed inside the one or more communication devices 104 is Mac. In yet another example, the operating system installed inside the one or more communication devices 104 is Linux based operating system. In yet another example, the operating system installed inside the one or more communication devices 104 is Chrome OS. In yet another example, the operating system installed inside the one or more communication devices 104 may be one of UNIX, Kali Linux, and the like. However, the operating system is not limited to above mentioned operating systems.

In an embodiment of the present disclosure, the one or more communication devices 104 operate on any version of windows operating system. In another embodiment of the present disclosure, the one or more communication devices 104 operate on any version of Mac operating system. In yet another embodiment of the present disclosure, the one or more communication devices 104 operate on any version of Linux operating system. In yet another embodiment of the present disclosure, the one or more communication devices 104 operate on any version of Chrome OS. In yet another embodiment of the present disclosure, the one or more communication devices 104 operate on any version of particular operating system corresponding to above mentioned operating systems.

The interactive computing environment 100 includes the one or more communication devices 104. The one or more communication devices 204 provide an interface for the plurality of users 102 to interact with the interactive computing environment 100. The plurality of users 102 can interact with the interactive computing environment 100 through more than one device of the one or more communication devices 104. In an example, a user U1 connects with the interactive computing environment 100 through a communication device D1 (let's say a smartphone) to watch video on demand at home. In another example, a user U2 connects with the computing environment 100 through a communication device D2 (let's say a desktop computer) at home. The user U3 connects with the computing environment 100 with a communication device D3 (let's say a tablet) while travelling.

Each of the one or more communication devices 104 comprises of a memory. In general, the memory includes computer-storage media in the form of volatile and/or nonvolatile memory. The memory may be removable, non-removable, or a combination thereof. Exemplary hardware devices include solid-state memory, hard drives, optical-disc drives, etc. The memory is coupled with one or more processors. In general, the one or more processor read data from various entities such as memory or I/O components. The one or more processor execute the one or more instructions which are stored in the memory. The one or more processors provide execution method for one or more instructions provided by the practitioner hunting system 110.

The interactive computing environment 100 includes the communication network 106. The one or more communication devices 104 is connected to the communication network 106. The communication network 106 provides a medium for the plurality of users 102 accessing the global index of the plurality of arts practitioners 108 to connect with the practitioner hunting system 110. In an embodiment of the present disclosure, the communication network 106 is an internet connection. In another embodiment of the present disclosure, the communication network 106 is a wireless mobile network. In yet another embodiment of the present disclosure, the communication network 106 is a wired network with a finite bandwidth. In yet another embodiment of the present disclosure, the communication network 106 is a combination of the wireless and the wired network for the optimum throughput of data transmission. In yet another embodiment of the present disclosure, the communication network 106 is an optical fiber high bandwidth network that enables a high data rate with negligible connection drops. The communication network 106 includes a set of channels. Each channel of the set of channels supports a finite bandwidth. Moreover, the finite bandwidth of each channel of the set of channels is based on capacity of the communication network 106. The communication network 106 connects the one or more communication devices 104 to the practitioner hunting system 110 using a plurality of methods. The plurality of methods used to provide network connectivity to the one or more communication devices 104 includes 2G, 3G, 4G, 5G, Wifi and the like.

The interactive computing environment 100 includes the plurality of arts practitioners 108. The plurality of arts practitioners 108 include but may not be limited to recording studios, art studios, songwriters, certified music producers, and audio engineers. In an example, a user U1 searches for the recording studios on the global index through a communication device D1 (let's say a smartphone) at home. In another example, a user U2 searches for the art studios on the global index through a communication device D2 (let's say a desktop computer) at home. In yet another example, a user U3 searches for the songwriters on the global index through a communication device D3 (let's say a tablet) while travelling.

The interactive computing environment 100 includes the practitioner hunting system 110 which is associated with the plurality of arts practitioners 108 and the plurality of users 102. In an embodiment of the present disclosure, the practitioner hunting system 110 corresponds to android operating system compatible application. In another example, the practitioner hunting system 110 corresponds to windows operating system compatible application. In yet another example, the practitioner hunting system 110 corresponds to iPhone operating system compatible application. In yet another example, the practitioner hunting system 110 corresponds to mac operating system compatible application. In yet another example, the practitioner hunting system 110 corresponds to web-based application run on a plurality of web browsers installed on the one or more communication devices 104. In an example, the plurality of web browsers includes but may not be limited to Opera, Mozilla Firefox, Google Chrome, Internet Explorer, Microsoft Edge, Safari and UC Browser. Further, the plurality of web browsers installed on the one or more communication devices 104 runs on any version of the respective web browser of the above-mentioned web browsers. In an example, a user U1 navigates the script writers in California. In another example, a user U2 searches for music directors for Boston.

The practitioner hunting system 110 provides the global index that includes a browsable catalog of the plurality of arts practitioners 108 that allows the plurality of users 102 to navigate the information associated with the plurality of arts practitioners 108. The browsable catalog includes the information generated by the plurality of arts practitioners 108 about the various products/services featured on the global index. In addition, the information includes editorial descriptions, reviews, and/or recommendations of the products/services that assist the plurality of users 102 in navigating or booking any of the plurality of arts practitioners 108. Further, the browsable catalog served by the global index includes special hyperlinks for allowing the plurality of users 102 to select the products/services for prospective booking.

The practitioner hunting system 110 enables each of the plurality of users 102 to navigate the information associated with the plurality of arts practitioners 108 and place a request on the one or more communication devices 104. In addition, the request is based on a plurality of parameters. Further, the plurality of parameters includes but may not be limited to an identification of a physical location and a context of the request. Furthermore, the context of the request includes at least one of type of product/service information, type of the plurality of arts practitioners 108, type of at least one mapping module, experience of the plurality of arts practitioners 108, a user profile and an explicit rating of the plurality of arts practitioners 108. Moreover, the physical location is identified based on present or real-time location of any of the plurality of users 102. Also, the physical location is identified based on sensors or applications installed inside the one or more communication devices 104.

The practitioner hunting system 110 retrieves at least one arts practitioner from the plurality of arts practitioners 108 using the global index based on the request of each of the plurality of users. In addition, the at least one arts practitioner from the plurality of arts practitioners 108 is retrieved in real-time.

The practitioner hunting system 110 displays the at least one arts practitioner and the physical location on the one or more communication devices 104 of the plurality of users 102. In addition, the at least one arts practitioner and the physical location are displayed on display of the one or more communication devices 104 in real-time.

In an embodiment of the present disclosure, the practitioner hunting system 110 installed on the one or more communication devices 104 receives from at least one user of the plurality of users 102 a booking request to book the at least one arts practitioner of the plurality of arts practitioners 108. In another embodiment of the present disclosure, the practitioner hunting system 110 run on the server 112 receives from the at least one user of the plurality of users 102 the booking request to book the at least one arts practitioner of the plurality of arts practitioners 108.

In an embodiment of the present disclosure, the practitioner hunting system 110 installed on the one or more communication devices 104 receives a confirmation from the at least one arts practitioner of the plurality of arts practitioners 108 and an acceptance from the at least one arts practitioner of the plurality of arts practitioners 108 accepting special instructions of the plurality of users 102 included in the booking request. In another embodiment of the present disclosure, the practitioner hunting system 110 run on the server 112 receives the confirmation from the at least one arts practitioner of the plurality of arts practitioners 108 and the acceptance from the at least one arts practitioner of the plurality of arts practitioners 108 accepting the special instructions of the plurality of users 102 included in the booking request.

In an embodiment of the present disclosure, the practitioner hunting system 110 installed on the one or more communication devices 104 processes a payment transaction between the at least one user of the plurality of users 102 and the at least one arts practitioner of the plurality of arts practitioners 108 for finalizing the booking request. In another embodiment of the present disclosure, the practitioner hunting system 110 run on the server 112 processes the payment transaction between the at least one user of the plurality of users 102 and the at least one arts practitioner of the plurality of arts practitioners 108 for finalizing the booking request.

In an embodiment of the present disclosure, the practitioner hunting system 110 installed on the one or more communication devices 104 weighs the at least one arts practitioner of the plurality of arts practitioners 108 based on information reflective of affinity of the at least one user of the plurality of users 102 for corresponding arts practitioner, such that at least some of the plurality of arts practitioners 108 are weighted differently than others. In another embodiment of the present disclosure, the practitioner hunting system 110 run on the server 112 weighs the at least one arts practitioner of the plurality of arts practitioners 108 based on information reflective of affinity of the at least one user of the plurality of users 102 for corresponding arts practitioner, such that at least some of the plurality of arts practitioners 108 are weighted differently than others. In addition, the amounts by which the at least one arts practitioner is weighted influences a likelihood that the at least one arts practitioner will be selected to recommend to the plurality of users 102. Further, weighting the at least one arts practitioner by an amount that depends upon the explicit rating by the corresponding user of the plurality of users 102. In an embodiment of the present disclosure, the practitioner hunting system 110 allows the plurality of users 102 to interactively rate the at least one arts practitioner of the plurality of arts practitioners 108 on a scale of 1-5.

In an embodiment of the present disclosure, the practitioner hunting system 110 installed on the one or more communication devices 104 integrates at least one mapping module with the global index for enabling each of the plurality of users 102 to navigate the information associated with the plurality of arts practitioners 108 directly to the physical location on at least one map of the at least one mapping module. In another embodiment of the present disclosure, the practitioner hunting system 110 run on the server 112 integrates the at least one mapping module with the global index for enabling each of the plurality of users 102 to navigate the information associated with the plurality of arts practitioners 108 directly to the physical location on the at least one map of the at least one mapping module. In addition, the at least one mapping module includes but may not be limited to Waze, Google Maps, Uber, Lyft, BackCountry Navigator, MapFactor, HERE WeGo Maps, MapQuest and Polaris GPS Navigation.

In an embodiment of the present disclosure, the practitioner hunting system 110 installed on the one or more communication devices 104 receives a registration of the at least one arts practitioner of the plurality of arts practitioners 108 at the global index. In another embodiment of the present disclosure, the practitioner hunting system 110 run on the server 112 receives the registration of the at least one arts practitioner of the plurality of arts practitioners 108 at the global index.

In an embodiment of the present disclosure, the practitioner hunting system 110 installed on the one or more communication devices 104 receives the product/service information of the at least one arts practitioner of the plurality of arts practitioners 108. In another embodiment of the present disclosure, the practitioner hunting system 110 run on the server 112 receives the product/service information of the at least one arts practitioner of the plurality of arts practitioners 108.

In an embodiment of the present disclosure, the practitioner hunting system 110 installed on the one or more communication devices 104 receives local service settings of the at least one arts practitioner of the plurality of arts practitioners 108. In another embodiment of the present disclosure, the practitioner hunting system 110 run on the server 112 receives the local service settings of the at least one arts practitioner of the plurality of arts practitioners 108.

In an embodiment of the present disclosure, the practitioner hunting system 110 installed on the one or more communication devices 104 updates a status of the product/service information and the local service settings of the at least one arts practitioner of the plurality of arts practitioners. In another embodiment of the present disclosure, the practitioner hunting system 110 run on the server 112 receives the product/service information of the at least one arts practitioner of the plurality of arts practitioners 108.

The interactive computing environment 100 further includes the server 112 and the database 114. The practitioner hunting system 110 is associated with the server 112. In general, server is a computer program or device that provides functionality for other programs or devices. The server 112 provides various functionalities, such as sharing data or resources among multiple users, or performing computation for a user. However, those skilled in the art would appreciate that the practitioner hunting system 110 is connected to more number of servers. Furthermore, it may be noted that the server 112 includes the database 114. However, those skilled in the art would appreciate that more number of the servers include more numbers of database.

In an embodiment of the present disclosure, the practitioner hunting system 110 is located in the server 112. In another embodiment of the present disclosure, the practitioner hunting system 110 is connected with the server 112. In yet another embodiment of the present disclosure, the practitioner hunting system 110 is a part of the server 112. The server 112 handles each operation and task performed by the practitioner hunting system 110. The server 112 stores one or more instructions for performing the various operations of the practitioner hunting system 110. The server 112 is located remotely from the practitioner hunting system 110. The server 112 is associated with the administrator 116. In addition, the administrator 116 manages the different components in the practitioner hunting system 110. The administrator 116 coordinates the activities of the components involved in the practitioner hunting system 110. The administrator 116 is any person or individual who monitors the working of the practitioner hunting system 110 and the server 112 in real-time. The administrator 116 monitors the working of the practitioner hunting system 110 and the server 112 through a communication device. The communication device includes the laptop, the desktop computer, the tablet, a personal digital assistant and the like.

The database 114 stores different sets of information associated with various components of the practitioner hunting system 110. In addition, the database 114 is used to hold general information and specialized data, such as characteristics data of the plurality of users 102, data of the one or more communication devices 104, data of the plurality of arts practitioners 108 and the like. The database 114 stores the information of the plurality of arts practitioners 108, the one or more communication devices 104, the profiles of the plurality of users 102, demographic information of the plurality of users 102 and the like. The database 114 organizes the data using model such as relational models or hierarchical models. Further, the database 114 store data provided by the administrator 116.

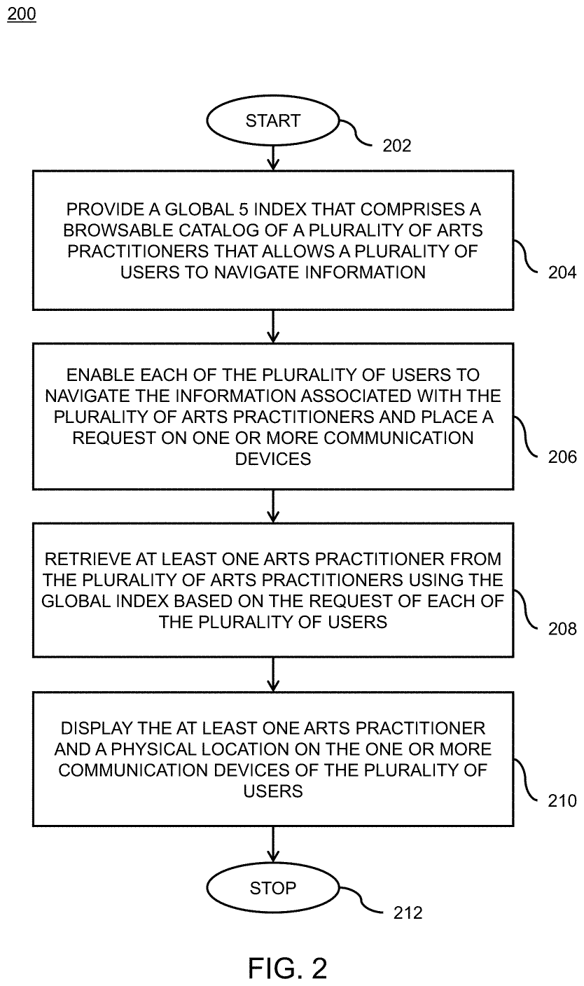

FIG. 2 illustrates a flow chart 200 of the method to implement the global index of the plurality of arts practitioners 108, in accordance with various embodiments of the present disclosure. It may be noted that in order to explain the method steps of the flow chart 200, references will be made to the elements explained in FIG. 1. The flow chart 200 starts at step 202. At step 204, the practitioner hunting system 110 provides the global index that includes the browsable catalog of the plurality of arts practitioners 108 that allows the plurality of users 102 to navigate the information associated with the plurality of arts practitioners 108. At step 206, the practitioner hunting system 110 enables each of the plurality of users 102 to navigate the information associated with the plurality of arts practitioners 108 and place the request on the one or more communication devices 104. At step 208, the practitioner hunting system 110 retrieves the at least one arts practitioner from the plurality of arts practitioners 108 using the global index based on the request of each of the plurality of users 102. At step 210, the practitioner hunting system 110 displays the at least one arts practitioner and the physical location on the one or more communication devices 104 of the plurality of users 102.

The flow chart 200 terminates at step 212. It may be noted that the flow chart 200 is explained to have above stated process steps; however, those skilled in the art would appreciate that the flow chart 200 may have more/less number of process steps which may enable all the above stated embodiments of the present disclosure.

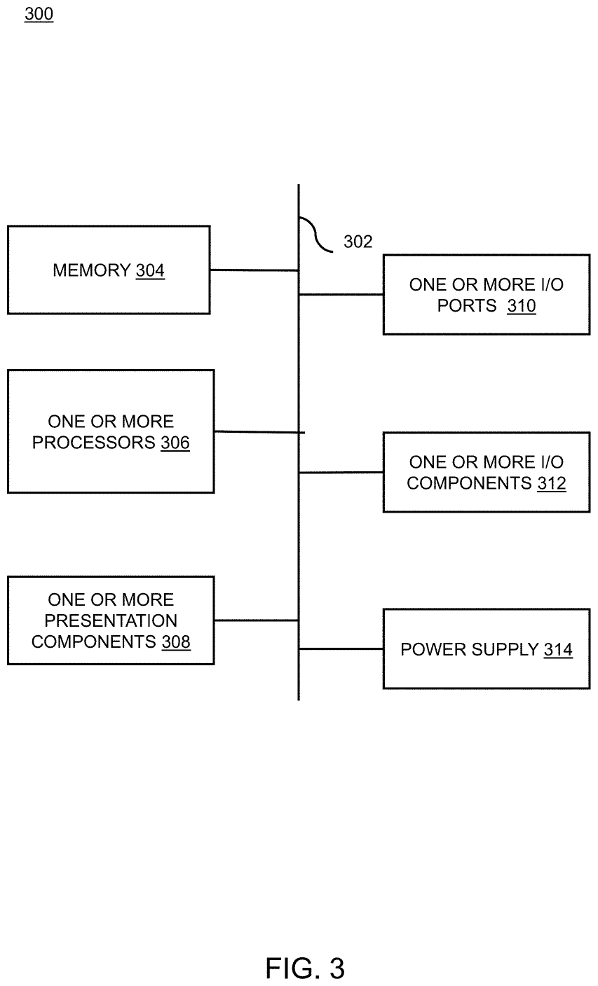

FIG. 3 illustrates a block diagram of a computing device 300, in accordance with various embodiments of the present disclosure. The computing device 300 includes a bus 302 that directly or indirectly couples the following devices: a memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary computing device 300 that can be used in connection with one or more embodiments of the present invention. Distinction is not made between such categories as “workstation,” “server,” “laptop,” “hand-held device,” etc., as all are contemplated within the scope of FIG. 3 and reference to “computing device.”

The computing device 300 typically includes a variety of computer-readable media. The computer-readable media can be any available media that can be accessed by the computing device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data.

The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The computing device 300 includes one or more processors that read data from various entities such as memory 304 or I/O components 312. The one or more presentation components 308 present data indications to a user or other device. Exemplary presentation components include a display device, speaker, printing component, vibrating component, etc. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

We claim:

1. A computer-implemented method for implementing a global index of a plurality of arts practitioners, the computer-implemented method comprising:
providing, by a practitioner hunting system with a processor, the global index that comprises a browsable catalog of the plurality of arts practitioners that allows a plurality of users to navigate information associated with the plurality of arts practitioners;
enabling, by the practitioner hunting system with the processor, each of the plurality of users to navigate the information associated with the plurality of arts practitioners and place a request on one or more communication devices, wherein the request is based on a plurality of parameters, wherein the plurality of parameters comprising an identification of a physical location and a context of the request;
retrieving, by the practitioner hunting system with the processor, at least one arts practitioner from the plurality of arts practitioners using the global index based on the request of each of the plurality of users, wherein the at least one arts practitioner from the plurality of arts practitioners is retrieved in real-time; and
displaying, by the practitioner hunting system with the processor, the at least one arts practitioner and the physical location on the one or more communication devices of the plurality of users, wherein the at least one arts practitioner and the physical location are displayed in real-time.

2. The computer-implemented method as recited in claim 1, wherein the computer-implemented method further comprising:
receiving, at the practitioner hunting system with the processor, from at least one user of the plurality of users a booking request to book the at least one arts practitioner of the plurality of arts practitioners;
receiving, at the practitioner hunting system with the processor, a confirmation from the at least one arts practitioner of the plurality of arts practitioners and an acceptance from the at least one arts practitioner of the plurality of arts practitioners accepting special instructions of the plurality of users included in the booking request; and
processing, at the practitioner hunting system with the processor, a payment transaction between the at least one user of the plurality of users and the at least one arts practitioner of the plurality of arts practitioners for finalizing the booking request.

3. The computer-implemented method as recited in claim 1, further comprising weighting, by the practitioner hunting system with the processor, the at least one arts practitioner of the plurality of arts practitioners based on information reflective of affinity of the at least one user of the plurality of users for corresponding arts practitioner, such that at least some of the plurality of arts practitioners are weighted differently than others, wherein the amounts by which the at least one arts practitioner is weighted influences a likelihood that the at least one arts practitioner will be selected to recommend to the plurality of users, wherein weighting the at least one arts practitioner by an amount that depends upon an explicit rating by the corresponding user of the plurality of users.

4. The computer-implemented method as recited in claim 1, further comprising integrating, by the practitioner hunting system with the processor, at least one mapping module with the global index for enabling each of the plurality of users to navigate the information associated with the plurality of arts practitioners directly to the physical location on at least one map of the at least one mapping module.

5. The computer-implemented method as recited in claim 1, wherein the computer-implemented method further comprising:
receiving, at the practitioner hunting system with the processor, a registration of the at least one arts practitioner of the plurality of arts practitioners at the global index;
receiving, at the practitioner hunting system with the processor, product/service information of the at least one arts practitioner of the plurality of arts practitioners;
receiving, at the practitioner hunting system with the processor, local service settings of the at least one arts practitioner of the plurality of arts practitioners; and
updating, at the practitioner hunting system with the processor, a status of the product/service information and the local service settings of the at least one arts practitioner of the plurality of arts practitioners.

6. The computer-implemented method as recited in claim 1, wherein the global index corresponds to a global chart that has substantially all information associated with the plurality of arts practitioners.

7. The computer-implemented method as recited in claim 1, wherein the context of the request comprises at least one of type of product/service information, type of the plurality of arts practitioners, type of at least one mapping module, experience of the plurality of arts practitioners, a user profile and an explicit rating of the plurality of arts practitioners.

8. A computer system comprising:
one or more processors; and
a memory coupled to the one or more processors, the memory for storing instructions which, when executed by the one or more processors, cause the one or more processors to perform a method for implementing a global index of a plurality of arts practitioners, the method comprising:
providing, by a practitioner hunting system, the global index that comprises a browsable catalog of the plurality of arts practitioners that allows a plurality of users to navigate information associated with the plurality of arts practitioners;
enabling, by the practitioner hunting system, each of the plurality of users to navigate the information associated with the plurality of arts practitioners and place a request on one or more communication devices, wherein the request is based on a plurality of parameters, wherein the plurality of parameters comprising an identification of a physical location and a context of the request;
retrieving, by the practitioner hunting system, at least one arts practitioner from the plurality of arts practitioners using the global index based on the request of each of the plurality of users, wherein the at least one arts practitioner from the plurality of arts practitioners is retrieved in real-time; and
displaying, by the practitioner hunting system, the at least one arts practitioner and the physical location on the one or more communication devices of the plurality of users, wherein the at least one arts practitioner and the physical location are displayed in real-time.

9. The computer system as recited in claim 8, wherein the method further comprising:
receiving, at the practitioner hunting system, from at least one user of the plurality of users a booking request to book the at least one arts practitioner of the plurality of arts practitioners;
receiving, at the practitioner hunting system, a confirmation from the at least one arts practitioner of the plurality of arts practitioners and an acceptance from the at least one arts practitioner of the plurality of arts practitioners accepting special instructions of the plurality of users included in the booking request; and
processing, at the practitioner hunting system, a payment transaction between the at least one user of the plurality of users and the at least one arts practitioner of the plurality of arts practitioners for finalizing the booking request.

10. The computer system as recited in claim 8, further comprising weighting, by the practitioner hunting system, the at least one arts practitioner of the plurality of arts practitioners based on information reflective of affinity of the at least one user of the plurality of users for corresponding arts practitioner, such that at least some of the the plurality of arts practitioners are weighted differently than others, wherein the amounts by which the at least one arts practitioner is weighted influences a likelihood that the at least one arts practitioner will be selected to recommend to the plurality of users, wherein weighting the at least one arts practitioner by an amount that depends upon an explicit rating by the corresponding user of the plurality of users.

11. The computer system as recited in claim 8, further comprising integrating, by the practitioner hunting system, at least one mapping module with the global index for enabling each of the plurality of users to navigate the information associated with the plurality of arts practitioners directly to the physical location on at least one map of the at least one mapping module.

12. The computer system as recited in claim 8, wherein the method further comprising:
receiving, at the practitioner hunting system, a registration of the at least one arts practitioner of the plurality of arts practitioners at the global index;
receiving, at the practitioner hunting system, product/service information of the at least one arts practitioner of the plurality of arts practitioners;
receiving, at the practitioner hunting system, local service settings of the at least one arts practitioner of the plurality of arts practitioners; and
updating, at the practitioner hunting system, a status of the product/service information and the local service settings of the at least one arts practitioner of the plurality of arts practitioners.

13. The computer system as recited in claim 8, wherein the global index corresponds to a global chart that has substantially all information associated with the plurality of arts practitioners.

14. The computer system as recited in claim 8, wherein the context of the request comprises at least one of type of product/service information, type of the plurality of arts practitioners, type of at least one mapping module, experience of the plurality of arts practitioners, a user profile and an explicit rating of the plurality of arts practitioners.

15. A non-transitory computer-readable storage medium encoding computer executable instructions that, when executed by at least one processor, performs a method for implementing a global index of a plurality of arts practitioners, the method comprising:
providing, by a computing device, the global index that comprises a browsable catalog of the plurality of arts practitioners that allows a plurality of users to navigate information associated with the plurality of arts practitioners;
enabling, by the computing device, each of the plurality of users to navigate the information associated with the plurality of arts practitioners and place a request on one or more communication devices, wherein the request is based on a plurality of parameters, wherein the plurality of parameters comprising an identification of a physical location and a context of the request;
retrieving, by the computing device, at least one arts practitioner from the plurality of arts practitioners using the global index based on the request of each of the plurality of users, wherein the at least one arts practitioner from the plurality of arts practitioners is retrieved in real-time; and
displaying, by the computing device, the at least one arts practitioner and the physical location on the one or more communication devices of the plurality of users, wherein the at least one arts practitioner and the physical location are displayed in real-time.
